(19) United States
(12) Patent Application Publication
(10) Pub. No.: US 2012/0061951 A1
(43) Pub. Date: Mar. 15, 2012

(54) LOTTERY GAMES AND GAMING PLATFORM

(76) Inventors: Jefferson Upshaw, Atlanta, GA (US); Kyle Lewis, Blacksburg, VA (US); Brian M. Locascio, Smyrna, GA (US); John T. Spear, Decatur, GA (US); Bill Pauls, Atlanta, GA (US); Todd Copilevitz, Atlanta, GA (US); Debra Riley Draper, Atlanta, GA (US); Ian D. MacKellar, Oakville (CA); Todd Michael Cornelius, Toronto (CA); Christopher Joakim, Toronto (CA); Gonzalo Cerezo Mata, Madrid (ES); Mark McMullen, Mableton, GA (US); James Michael Bernardoni, Chicago, IL (US)

(21) Appl. No.: 13/050,668

(22) Filed: Mar. 17, 2011

Related U.S. Application Data
(60) Provisional application No. 61/314,873, filed on Mar. 17, 2010.

(51) Int. Cl. B42D 15/00

(52) U.S. Cl. 283/102

(57) ABSTRACT

Systems, methods, and lottery tickets provide lottery games with gameplay that allows a variety of play options and results a rich prize structure. Gameplay can be centered on a lottery game player or a related entity, which can comprise other lottery game players. Gameplay centered on the lottery game player can be customized to a specific segment associated therewith. Play options can include iterative gameplay and gameplay reliant on information supplied by the game player. Features of the rich prize structure include monetary prizes that can include cash awards and non-cash awards. Monetary prizes can be awarded in response to active game play or passive gameplay. Other monetary prizes can be redeemed during a period of time and can include award terms that benefit the lottery game player or the related entity (relative(s) of the lottery game player, non-profit organization(s), prize supplier(s), etc.).

### CROSS-REFERENCE TO RELATED APPLICATION

This application relates to and claims priority from U.S. Provisional Application No. 61/314,873, filed on Mar. 17, 2010, and entitled “LOTTERY GAME AND METHOD OF PLAYING THE SAME,” which is incorporated herein by reference in its entirety.

### SUMMARY

In accordance with various aspects and exemplary embodiments described herein, the subject disclosure generally relates to lottery games with gameplay that allows a variety of play options and results a rich prize structure. Gameplay can be centered on a lottery game player or a related entity, which can comprise other lottery game players. Gameplay centered on the lottery game player can be customized to a specific segment associated therewith. Play options can include iterative gameplay and gameplay reliant on information supplied by the game player. Features of the rich prize structure include monetary prizes that can include cash awards and non-cash awards. Monetary prizes can be awarded in response to active game play or passive gameplay. Other monetary prizes can be redeemed during a period of time and can include award terms that benefit the lottery game player or the related entity (relative(s) of the lottery game player, non-profit organization(s), prize supplier(s), etc.).

The subject disclosure provides several advantages with respect to conventional lottery games. For example, an advantage is increased lottery game player enjoyment and participation, with ensuing increase in lottery sales and attendant money prizes. For another example, an advantage is broad national interest and demographic engagement. For another example, an advantage is availability of a rich prize structure that enables complex profit planning and systematic exploitation of profit opportunities for a lottery operator, and extension of prize awards in time and scope.

Additional aspects, features, or advantages of the subject disclosure will be set forth in part in the description which follows, and in part will be obvious from the description, or may be learned by practice of the subject disclosure. The advantages of the subject disclosure will be realized and attained by means of the elements and combinations particularly pointed out in the appended claims. It is to be understood that both the foregoing general description and the following detailed description are exemplary and explanatory only and are not restrictive of the subject disclosure.

### BRIEF DESCRIPTION OF THE DRAWINGS

The accompanying drawings are incorporated and illustrate exemplary embodiment(s) of the subject disclosure and together with the description and claims appended hereto serve to explain various principles, features, or aspects of the subject disclosure.

FIG. 1 illustrates an exemplary gaming environment in accordance with aspects of the subject disclosure.

FIG. 2 illustrates an exemplary embodiment of a gaming platform in accordance with aspects described herein.

FIG. 3 illustrates an exemplary rendering for conveying collective outcome of gameplay of a lottery game in accordance with aspects of the subject innovation.

FIG. 4 illustrates a high-level diagram of a lottery ticket in accordance with aspects of the subject disclosure.

FIGS. 5A-5G illustrates various exemplary lottery tickets in accordance with aspects of the subject disclosure.

FIG. 6 illustrates an exemplary gaming method in accordance with aspects of the subject innovation.

FIG. 7 illustrates a block diagram of an exemplary operating environment that enables various features of the subject disclosure and performance of the various methods disclosed herein.

### DETAILED DESCRIPTION

The subject disclosure may be understood more readily by reference to the following detailed description of exemplary embodiments of the subject disclosure and to the Figures and their previous and following description.

Before the present compounds, compositions, articles, devices, and/or methods are disclosed and described, it is to be understood that the subject disclosure is not limited to specific systems, methods, and lottery tickets for lottery games with gameplay that allows a variety of play options and results a rich prize structure. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

In the subject specification and in the claims which follow, reference may be made to a number of terms which shall be defined to have the following meanings: “Optional” or “optionally” means that the subsequently described event or circumstance may or may not occur, and that the description includes instances where said event or circumstance occurs and instances where it does not.

As employed in this specification and annexed drawings, the terms “unit,” “component,” “interface,” “system,” “platform,” and the like are intended to include a computer-related entity or an entity related to an operational apparatus with one or more specific functionalities, wherein the computer-related entity or the entity related to the operational apparatus can be either hardware, a combination of hardware and software, software, or software in execution. One or more of such entities are also referred to as “functional elements.” As an example, a unit may be, but is not limited to being, a process running on a processor, a processor, an object, an executable computer program, a thread of execution, a program, a memory (e.g., a hard disc drive), and/or a computer. As another example, a unit can be an apparatus with specific functionality provided by mechanical parts operated by electric or electronic circuitry which is operated by a software or a firmware application executed by a processor, wherein the processor can be internal or external to the apparatus and executes at least a part of the software or firmware application. In addition or in the alternative, a unit can provide specific functionality based on physical structure or specific arrangement of hardware elements. As yet another example, a unit can be an apparatus that provides specific functionality through electronic functional elements without mechanical parts, the electronic functional elements can include a processor therein to execute software or firmware that provides at least in part the functionality of the electronic functional elements. An illustration of such apparatus can be control circuitry, such as a programmable logic controller. The foregoing example and related illustrations are but a few examples and are not intended to be limiting. Moreover, while such illustrations are presented for a unit, the foregoing examples also apply to a component, a system, a platform, and the like. It is noted that in certain embodiments, or in connection with certain aspects or features thereof, the terms “unit,” “component,” “system,” “interface,” “platform” can be utilized interchangeably.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Reference will now be made in detail to the various embodiment(s), aspects, and features of the subject disclosure, example(s) of which are illustrated in the accompanying drawings. Wherever possible, the same reference numbers are used throughout the drawings to refer to the same or like parts.

There are numerous conventional lottery games, comprising instant scratch-off game tickets and lottery jackpot tickets, which provide prize amounts and wherein the skill of the player is normally not a factor. These games are often run by state governmental or governmental-approved agencies or organizations in order to raise revenues.

As described in greater detail below, the subject disclosure provide lottery games with gameplay that allows a variety of play options and results a rich prize structure. Gameplay can be centered on a lottery game player or a related entity, which can comprise other lottery game players. Gameplay centered on the lottery game player can be customized to a specific segment associated therewith. Play options can include iterative gameplay and gameplay reliant on information supplied by the game player. Features of the rich prize structure include monetary prizes that can include cash awards and non-cash awards. Monetary prizes can be awarded in response to active game play or passive gameplay. Other monetary prizes can be redeemed during a period of time and can include award terms that benefit the lottery game player or the related entity (relative(s) of the lottery game player, non-profit organization(s), prize supplier(s), etc.).

It should be appreciated that several aspects or features, and related advantages, are described with reference to a lottery ticket, the subject disclosure is not so limited and such aspects or features can be implemented or exploited in connection with a gaming instrument unit (also referred to as gaming instrument or gaming unit) which enables gameplay of a lottery game and is embodied in user equipment (UE) or a user device (e.g., a mobile telephone, a mobile computer, a Personal Digital Assistant, or the like), customer premises equipment (CPE), or a point of sale (POS) device.

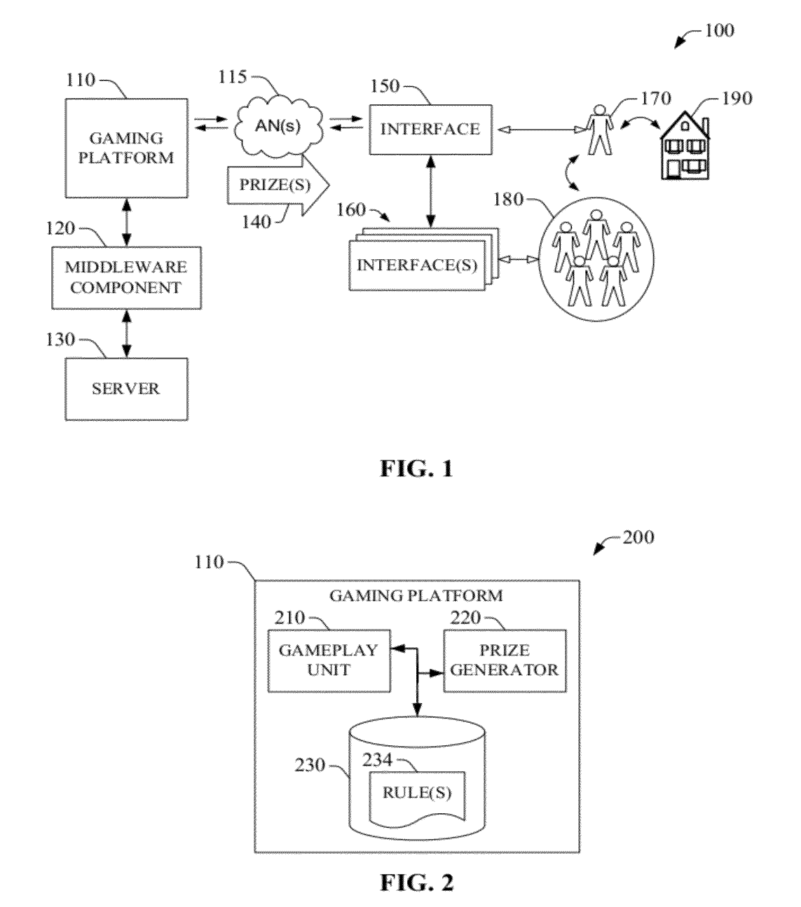

Referring to the drawings, FIG. 1 illustrates an exemplary gaming environment 100 in accordance with aspects of the subject disclosure. The gaming environment 100 includes a gaming platform 110 that can implement a lottery game in accordance with aspects of the subject disclosure. Gamming platform 110 can implement at least a portion of gameplay associated with the lottery game. In an aspect, gaming platform can carry out a set of one or more rules that define the lottery game. In an embodiment, e.g., exemplary embodiment 200 illustrated in FIG. 2, gaming platform 110 can include a gameplay unit 210 that applies (e.g., executes or implements) at least one rule of the one or more rules that define the lottery game. In an aspect, the at least one rule determines the lottery game by establishing one or more operations to be performed on certain data that is part of the lottery game. As an example, the rule can be selection of a set of one or more tokens (e.g., a 10-digit telephone number) from a domain of tokens (e.g., a plurality of 10-digit telephone numbers), wherein the selection is performed at a specific instant.

It should be appreciated that the one or more rules also determine the structure of a monetary prize associated with the lottery game. The monetary prize, represented as prize(s) 140, is awarded to a winning realization of the lottery game. Such winning realization generally is a set of one or more specific tokens (e.g., numbers) that fulfill at least one performance criterion. For example, in certain games a performance criterion can be a matching criterion which establishes a degree of agreement amongst the set of one or more specific parameters and a winning sequence of one or more tokens (e.g., numbers). In an aspect, degree of agreement can be complete, wherein each of the one or more specific tokens matches respective values of each of the tokens in the winning sequence of one or more tokens, and the order of the set of the one or more specific tokens is the same as the order of tokens in such winning sequence.

In an aspect, the monetary prize can be awarded to a lottery game player 170 (also referred to as player 170) or to a group of one or more individuals 180 related to the lottery game player 170; such relationship is represented with a curved arrow. It should be appreciated that an individual in the group 180 also can be a lottery player. In another aspect, the monetary prize can be awarded to both the lottery game player 170 and at least one individual of the group of one or more individuals 180. In yet another aspect, the monetary prize can be awarded to an entity 190 related to the lottery game player 170. For instance, the entity can be an organization, such as a charity or a school, related to the lottery game player 170; such relationship also is illustrated with a curved arrow.

As illustrated, the set of one or more rule(s) can be retained (stored, recorded, etc.) in a memory element 234 (e.g., a register, a file, a database, etc.) within a memory 230, or a computer-readable storage medium, which can be a non-transitory storage medium.

Gaming platform 110 can receive data related to the lottery game player 170 from a server 130 via a middleware component 120, which comprises a plurality of units that enable communication with a variety of service platforms such as billing platforms, customer service platforms, utility service platforms, consumer service platforms, location based services, or the like. Server 130 can be part of a service platform (e.g., a web-based service such as social networking websites). The characteristics of the data that is collected are dictated a rule of the one or more rules that determine the lottery game; the rule also can indicate a service platform from which data should be received. In addition, gaming platform 110 applies (e.g., implements or executes) the at least one rule to at least a portion of the data.

For the lottery game, gameplay also is effect in part by the lottery game player 170. In conventional lottery games interaction of the player 170 and gaming platform 110 is indirect and commonly occurs via a lottery ticket. In contrast, in the subject disclosure, a variety of lottery games, and related rule(s), allows direct interaction amongst the player 170 and the gaming platform 170, as described hereinafter. Moreover, one or more lottery games of the subject disclosure allow direct interaction of individuals in group 180 with gaming platform 110. In an aspect, interaction amongst player 170 and gaming platform 110 is enabled through interface 150 and access network(s) 115 (AN(s) 115). In another aspect, individuals in group 180 can interact directly with gaming platform 110 via a set of one or more interface(s) 160. In certain scenarios, as illustrated in gaming environment 100, an interface in the group of one or more interfaces 160 is functionally coupled to interface 150. However, in alternative or additional scenarios, an interface of the one or more interface(s) 160 can be directly linked (not shown) to gaming platform 110 via AN(s) 115.

Lottery player 170 and interface 150 can interact through a variety of gestures (speech gesture, motion gestures, aural gestures, etc.) which are represented with an open-arrow line. Likewise, an individual in group 180 also can interact one of interface(s) 160 via a variety of gestures (represented with an open-arrow line). In certain embodiments, interface 150 is embodied in a point-of-sale (POS) device with a rendering unit, such as a display. In one or more scenarios, interaction amongst player 170 and the POS device is via a lottery ticket. In other embodiments, interface 150 is embodied in user equipment (UE; which can be mobile tethered or otherwise), such as a user device or a wearable device, with a rendering unit (e.g., a display). It should be appreciated that in the subject disclosure, a user device coupled to the lottery game player 170 can operate in substantially the same manner as a lottery ticket comprising a substrate or medium and a plurality of indicia. Moreover, the through communication of specific data from a first UE embodying interface 150 to a second UE embodying one of interface(s) 160 via a short message service (SMS) communication, multimedia message service (MMS) communication, or other communication protocol (e.g., USSD) can cause the second UE to operate in substantially the same manner as lottery ticket. A device such as UE or CPE that operates as a lottery ticket is referred to herein as a gamming instrument. Thus, a first gaming instrument can render other device a gaming instrument.

Interface 150 can be configured to convey or redeem prize(s) 140 awarded to player 170. Similarly, yet not identically, an interface of the set of interface(s) 160 can be configured to convey or redeem prize(s) 140 directed to an individual in group 180. Thus, a functionality that can be accomplished in a scenario in which interface 150 is a UE is communication of indicia or tokens to a disparate interface and cause that disparate interface to be part of a gameplay of a lottery game initiated by the UE that embodies interface 150.

In an aspect of the subject disclosure, gaming platform 110 can expose the lottery game player 170 to a wealth of information associated with specific lottery games. Gaming platform 110 can cause interface 150 to render information related to a specific lottery game. In an aspect, gaming platform 110 can cause interface 150 to render such information by applying (e.g., executing) a rule related to a lottery game. To at least such end, gaming platform can supply data indicative of such information to interface 150 which can render the information.

In an embodiment, gaming platform 110 can deliver data indicative of a number Q of lottery players that are permitted to win a cash sum Σ. In an implementation, gaming platform 110 can deliver data indicative of a plurality of cash sums {Σ₁, Σ₂, . . . Σ_{P}}, with P being a natural number greater than 1, and a number Nₖ associated with Σ_{K} with K=1, 2 . . . P of players permitted to win such sums. Numbers Nk can be decreasing numbers whereas numbers Σ₁, Σ₂ . . . Σ_{P} can be inversely proportional to respective N_{K}. As an illustration, a pyramid 300 can be rendered, e.g., FIG. 3, in interface 150, where the base level of the pyramid 300 represents a larger number of permitted winners (e.g., 10,000,000 individuals) with the lowest winnings (e.g., $1), and the top level of the pyramid represents the largest winnings ($10,000,000) for the lowest number of permitted winners (e.g., 1 winner). In an aspect, interface 150 can render a number of available winnings for each level in the pyramid and winnings associated with the each level. It should be appreciated that a pyramid is just one example of a rendering; any representation that renders a hierarchical scheme in which a lower number of players are permitted to win a larger winnings. A lottery operator that owns, leases, or otherwise controls gaming platform 110 can select a suitable hierarchical structure.

In certain embodiments, gaming platform 110 can apply a set of one or more rules for a lottery game that exploits home addresses. In response to applying such set of rules, gaming platform 110, via gameplay unit 210, for example, can receive a home address or a portion thereof (e.g., street number, street name, city, state, country, or any combination thereof) for a lottery player 170. The home address or a portion thereof can be received from a location services platform, which can be embodied in server 130. In an aspect, gaming platform 110 can retain received home addresses in memory 230. In addition, it should be appreciated that gameplay unit 210 can collect the home address in response to the player 170 playing a lottery game (e.g., a name called “Ding Dong”) in which a bid for a winnings is embodied in a home address rather than a sequence of numbers or other type of tokens.

For such data, game play unit 210 can select a first home address and compare the first home address with a second home address extracted from a plurality of received home addresses (e.g., addresses available in memory 230). Performing a comparison amongst the first home address (e.g., address of a player 170) and the second home address (drawn address) can be a rule that is part of the one or more rules that define the lottery game. In response to a match amongst such two addresses, player 170 can be deemed a winner and be awarded a substantive cash prize or non-cash prize. In addition, individual(s) who reside in proximity of the first address also can win a cash prize that is smaller that the winnings of the player 170; for instance, the smaller price can be a 10% fraction of the winnings, a 20% fraction of the winnings, a 30% fraction of the winnings, etc.

In other alternatives, one or more individuals in group 180 who reside in proximity (e.g., same street block, same neighborhood, same apartment building, etc.) but did not play, or did not bid an address, also can win a cash prize (e.g., $1,000) or non-cash prize.

In another embodiment, gaming platform 110 can receive data indicative of authorization to bill a commercial account linked to a lottery game player 170 in response to purchase of a lottery ticket for a lottery game implemented by gaming platform 110. Such authorization can be germane to the mechanics of the lottery game, with the authorization enabling the lottery game player 170 to participate in the lottery game. The authorization can be supplied via interface 150. In an aspect, the commercial account enables a commercial transaction amongst the lottery game player a service provider (a utility company; a service provider such as; a financial organization such as a bank, a credit union, a lender; etc.), wherein the commercial transaction includes billing costs associated with purchase of lottery ticket(s). The commercial account can be embodied in a bank account, a credit card account, a utility billing account, a loyalty program account, or the like.

Moreover, gaming platform 110 can convey an instruction (e.g., a data packet) indicative of a billing request that enables a billing server to bill the commercial account. Such instruction can be conveyed in response to purchase of the lottery ticket for the lottery game. In an aspect, middleware component 120 can be distributed amongst a local area network of the lottery operator (not shown) and other LAN network of a financial institution that administers a billing server that effects the billing request; server 130 can embody the billing server.

In certain embodiments, interface 150 can be directly coupled to a server 130 that enables purchase of a lottery ticket from a retailer of choice of a player 170. Such purchase transaction can be web-based and, in such scenario, the server 130 can be an ecommerce server. In an aspect, server 130 can add cost of the lottery ticket to a bill related to a disparate commercial transaction with the retailer at a time such commercial transaction is completed. It should be appreciated that certain segments of lottery players that have an affinity for performing web-based transactions can be prone to engaging in purchasing lottery tickets in this fashion. In other aspects, bills related to the commercial account or to the web-based commercial transaction can be rounded up in order to pay for participation in the lottery game.

In one embodiment, gaming platform 110 can extracting a token and assign a cumulative winnings to a lottery game player 170 in response to a predetermined token (e.g., a number) in a predetermined sequence of tokens (e.g., a sequence of numbers) matching the token. In a scenario, the cumulative winnings is additive with respect to a previous cumulative winnings and a predetermined increment. Such matching can be a performance criterion that establishes a winning realization and thus affords assignment of the cumulative winnings. In an aspect, gameplay can proceed after a first match amongst an extracted token and a token in the predetermined sequence of tokens. Gameplay ends when the sequence of predetermined tokens has been matched in full through successive iterations of matches or in response to the lottery game player 170 terminating the gameplay. To terminate gameplay, the player 170 can submit via interface 150 an instruction indicative of termination of the gameplay.

As illustration of gameplay is the following. Lottery game player 170 can purchase online ticket. A number can be drawn each day for 7 days within each month. The first day the first number is drawn. If the player 170 has the drawn number, the player 170 wins $10. The second day the second number is drawn. If the player 170 continued the gameplay, and the player 170 has the second number, the player 170 wins $100. Gameplay can continue until the 7th number is drawn and the prize reaches a jackpot level of $10,000,000. The player 170 can cash in a cumulative winnings and at any point during gameplay. In certain scenarios, gaming platform 110 can implement the game in a manner that allows, at certain times during the week, player 170 to buy in a ticket at a much higher price for a chance to win a big jackpot at the next day's drawing.

In certain lottery games, server 130 can provide a plurality of clues indicative of a specific location. A clue can be a volume of information (e.g., a portion of written language, a symbol, an aural token, a tactile token, etc.) that conveys one or more features related to the specific location. In an aspect of such additional or alternative embodiments, to provide the clue, the server 130 can convey at least one clue of the plurality of clues to a user-device. The user-device can embody interface 150. In another aspect, server 130 can provide at least one clue of the plurality of clues to a manufacturing platform that produces a lottery ticket comprising a substrate having a representation of the at least one clue. The manufacturing platform can be a subsidiary of an entity that owns, leases, or otherwise controls the gaming platform (e.g., 110). In yet another aspect, server 130 can embed at least one clue of the plurality of clues in a television broadcast. For instance, the embedding can include generating custom advertisement of the lottery game, wherein the advertisement is conveyed as part of the television broadcast. In still another aspect, server 130 can embed at least one clue of the plurality of clues in a publication wherein the publication can be delivered or carried in various media such as an electronic book, a non-electronic book, a web-based publication, an aural publication such as a radio broadcast, a public announcement, an automated voice call, or the like.

At least one advantage of such a game is that enable a lottery operator that controls gaming platform 110 to aggressively market products while provide clues. In certain embodiments, to realize such advantage, the lottery operator can manage or otherwise control server 130.

In such additional or alternative embodiment, gaming platform 110, via game play unit 210, for example, can determine the specific location has been found. Various mechanisms can enable determination that a certain location has been found based on one or more clues; for instance, a user-device (a mobile telephone, a wireless computer, a portable computer that is either tethered or wireless, etc.) can be supply an image of identifying indicia coupled to a fixture in the specific location; the gaming platform or a unit therein, e.g., a prize generator 220, can perform an assessment of the image and based on an outcome of the assessment determined the specific location has been found. In the alternative, the user-device can supply an electronic communication (Short Message Service (SMS) communication, Multimedia Message Service (MMS) communication, email message, or any or most any data packet) in response to the identifying indicia matching other indicia present in a lottery ticket or, more generally, a gaming instrument (e.g., a rendering of a lottery ticket in a user-device display) or provided by one or more clues.

In certain embodiments, gaming platform 110, via prize generator 220, for example, can award a prize to one or more player (e.g., player 170 and/or one or more of individuals in group 180) in response to the specific location being found. Gaming platform 110 can award a winnings to one or more players based on a number of previous instances the specific location has been found.

In certain embodiments gaming platform 110 can implement a lottery game that exploits a pool of telephone numbers as a domain of tokens that enable gameplay of the lottery game, gaming platform 110 can receive data indicative of a telephone number of a user device of a lottery game player 170. In an aspect, the lottery game player 170 can supply such data via interface 150. In such scenario and in an aspect, gaming platform 110, via gameplay unit 210, can initiate a call session (e.g., a voice call or a data session) with the user device via the telephone number. Initiating the call session can be part of gameplay, as established by a set of one or more rules that define the lottery game. The call session can be at least one of a SMS communication, MMS communication, an Unstructured Supplementary Service Data (USSD) code, or a voice call. In another aspect, in response to failure to establish the call session (e.g., the voice call or the data session) with the user device, gaming platform 110, via gameplay unit 210, can initiate other call session with other user device associated with the lottery game player. For example, the other user device can be a user device linked to an individual in group 180.

In addition, in response to establishing the other call session with other user device, gaming platform 110, via prize generator 220, can award a first portion of a monetary prize to the lottery game player 170 and a second portion of the monetary prize to an individual (e.g., an individual in group 180) linked to the other user device. The first portion can equal the second portion (e.g., such as in a 50-50 split amongst a full available prize). It should be appreciated that other relative weights, or proportions, for the first portion and the second portion can be exploited; for instance the second portion can be larger (e.g., 60%, 70%, 80%, 90%, 95%) than the first portion (e.g., 40%, 30%, 20%, 10%, 5%) in view that establishing the other call session results in gaming platform 110 awarding the monetary prize. In an alternative aspect, gaming platform 110, via prize generator 220 award the monetary prize in response to establishing the call session with the user device linked to the player 170.

Based on one or more rules that define gameplay of a lottery game, gameplay unit 210 can deliver data indicative of a period available for spending a cash sum; such cash sum is a configurable value which can be established by a lottery operator that owns, leases, or otherwise controls gaming platform 110. As an example, the period can be 24 hours and the cash sum can be $24,000,000. Yet, it should be appreciated that any or most any period and any or most any cash sum can be exploited for gameplay of the lottery game. In addition, in such scenarios, gameplay unit can supply data indicative a rule for spending the cash sum. It should be appreciated that the rule can embody, at least in part, the one or more rules that define gameplay of the lottery game. In response to delivery of the rule for spending the Moreover, the collecting act can comprise receiving data representative of a spending plan in response to the delivering act. In such scenarios, the monetary prize equals the cash sum (e.g., $24,000,000) multiplied by a factor (e.g., 2, 3, 4, 5, 6, 7, 8, 9, 10, 15, 20, etc.) greater than unity.

In other embodiments, gaming platform 110 can receive data indicative of at least one individual associated with the lottery game player. Such data can be received from server(s) 130, wherein the server is configured to provide or provides service to a social networking service provider (e.g., Facebook). Moreover, gaming platform 110, via prize generator 220, can award a monetary prize to a lottery game player 170 and the at least one individual associated with the lottery game player (e.g., an individual in group 180).

In additional or alternative embodiments, gaming platform 110, via gameplay unit 210, can receive data indicative of a residential location of a lottery game player 170; the data indicative of the residential location comprises a geocode including at least one of a state code, an area code, or a ZIP code. In such additional or alternative embodiments, gaming platform 110 can award a monetary prize to one or more lottery game players having a common residential location. As an example, the monetary prize can be awarded to the lottery game player 170 and at least one individual in group 180 in response to an outcome of a gameplay for a lottery game dictating that a winning realization has been attained. It should be appreciated that in other embodiments, gaming platform 110, via gameplay unit 110, can receive data indicative of a commercial location of a lottery game player that is not an individual but rather the player is an institutional player or a bidder; for instance, the institutional game player can be a small business organization and the lottery game player can be a corporate tax deduction.

In one such embodiment, gaming platform 110 can issue a group of indicia (e.g., a plurality of symbols or tokens that are visual, aural, or tactile) representative of the location of the lottery game player 170. In one scenario, the group of indicia is printed onto a lottery ticket. In another scenario, the group of indicia is coated onto the lottery ticket. In yet another scenario, the group of indicia can be engraved onto the lottery ticket. In still another scenario, the group of indicia can be encoded (programmed in a memory, recorded in a memory, etc.) onto the lottery ticket, wherein the lottery ticket enables gameplay of the lottery game.

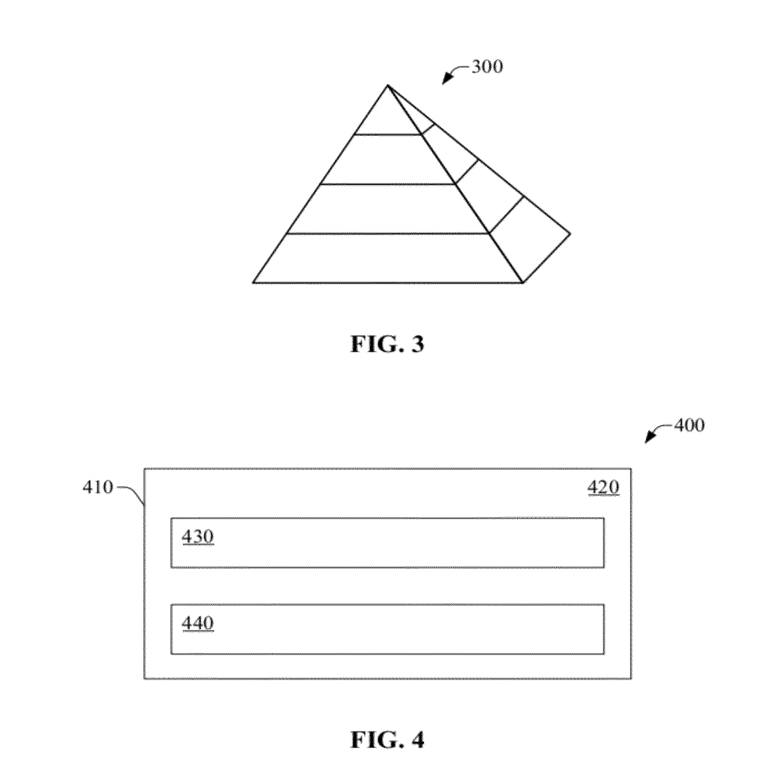

As illustrated in FIG. 4, for a lottery ticket 400, a plurality of indicia can be prepared in a substrate 410 of the lottery ticket 400. In the illustrated embodiment, the plurality of indicia can be configured into a first plurality of indicia 430 and a second plurality of indicia 440. The indicia can be prepared in the substrate 410. As used herein, “prepared in the substrate” means applied (e.g., printed, treated, affixed, evaporated, coated, painted, or the like) to the substrate or implemented (e.g., printed, treated, affixed, evaporated, coated, painted, or the like) into or onto the substrate. In one embodiment, the indicia can be applied to the substrate by printing.

As used herein, a substrate can be any material known in the art suitable for producing lottery tickets. For example, and not to be limiting, a substrate can be paperboard, cardstock, paper, plastic, or any other suitable material. In one embodiment, a substrate can be a computer-readable storage medium. In a further embodiment a substrate can be a flexible substrate.

As used herein, indicia can be any symbol or group of symbols that defines the games described herein. For example, and not to be limiting, the indicia can be a simple alphanumeric character a word, a picture, an image, or a physical indicia such as a hole in the ticket. In one embodiment, the indicia can represent a unique prize structure. In another embodiment, the indicia can be matched to other indicia on the tickets to determine a prize. In yet another embodiment, the indicia can be matched to predetermined indicia to determine a prize, for example through a drawing. The indicia can be a single indicia or a group if indicia depending on the lottery ticket. In certain embodiments, for example where a lottery game player plays the lottery game by selecting a group of symbols, there can be more than one indicia. In certain other embodiments, for example where a lottery game player plays the lottery game by removing a scratch off coating to expose the indicia, there can be one indicia. Therefore, described herein are lottery tickets comprising 1, 2, 3, 4, 5, 6, 7, 8, 9, 10, 11, 12, 13, 14, 15, 16, 17, 18, 19, 20, or greater than 20 indicia.

In one embodiment, the indicia can be a game outcome or result that is a dollar amount of a win, and can be a numerical representation of that amount. In another embodiment the indicia can be a symbol or a group of symbols representing an amount won or a prize that was won.

As used herein, a lottery game player can be a person or a group of people (e.g., group 180) who play a lottery game. In an aspect, a lottery game player can be a winning lottery game player. Therefore, in such embodiments and where the context does not dictate otherwise, the terms winning lottery game player and lottery game player can be used interchangeably. Additionally, the terms lottery game player and lottery game players can be used interchangeably. In a further embodiment, a winning lottery game player can be a selected lottery game player and a non-wining lottery game player can be a non-selected lottery game player.

As used herein to “obtain” a lottery ticket means to gain possession of a lottery ticket. For example, and not to be limiting, a lottery player can obtain a lottery ticket by purchasing a lottery ticket, by winning a lottery ticket, by being given a lottery ticket, or by finding a lottery ticket.

As used herein, monetary prize means any monetary instrument (currency papers, credit cards, gift cards (open loop and closed loop), letters of credit, loyalty-program cards, etc.) that has a value. For example, and not to be limiting, the monetary prize can be cash, a check, stocks, a credit card, a debit card, a card with a pre-set spending limit, a gift card, an online gift card, or another lottery ticket. In some embodiments, the monetary prize can be a cash prize. In other embodiments, the monetary prize can be a non-cash prize.

Described herein are lottery tickets, comprising: a substrate; a first plurality of lottery game indicia prepared in the substrate and that defines a lottery game; and a second plurality of lottery game indicia prepared in the substrate and conveying a monetary prize to a plurality of recipients. The monetary prize can be a cash prize or a non-cash prize and can be provided to a lottery game player at a single time or over a period of time. In some embodiments, the lottery tickets described herein can further comprise an electronic medium, including, but not limited to, a computer readable medium.

In one embodiment, at least a portion of the plurality of lottery game indicia can be covered by a scratch off coating, and at least a portion of the plurality of lottery game indicia can be exposed by removing the scratch off coating.

In one embodiment, the scratch off coating can be removed by a lottery game player. In another embodiment, the scratch off coating can be removed by an individual administering the lottery game. Administering the lottery game can include, but is not limited to, selling the lottery tickets, providing prizes to winning lottery game players, or determining if a lottery game player has a winning ticket. In a further aspect, the scratch off coating can be removed by a device.

In one embodiment, the first plurality of lottery game indicia can be delivered to a device in response to the purchase of the lottery ticket. For example, and not to be limiting, the device can be a cellular phone, a PDA, a desktop computer, a laptop computer, or a television. In another embodiment, the first plurality of lottery game indicia can be delivered to the device by text message, email, instant message, through a social networking site, a phone call, or downloaded directly to the device from a server.

In a further embodiment the lottery tickets described herein can have at least a portion of the first plurality of lottery game indicia comprising a set of fillable fields in which a lottery game player can input a group of symbols, wherein the last symbol in the group can represent a selected entity of choice. For example, and not to be limiting, the symbols can be letters, numbers, characters, or emoticons. As used herein, examples of an entity includes, but is not limited to a charitable organization, a college, a university, a church, a hospital, a public school, or a private school.

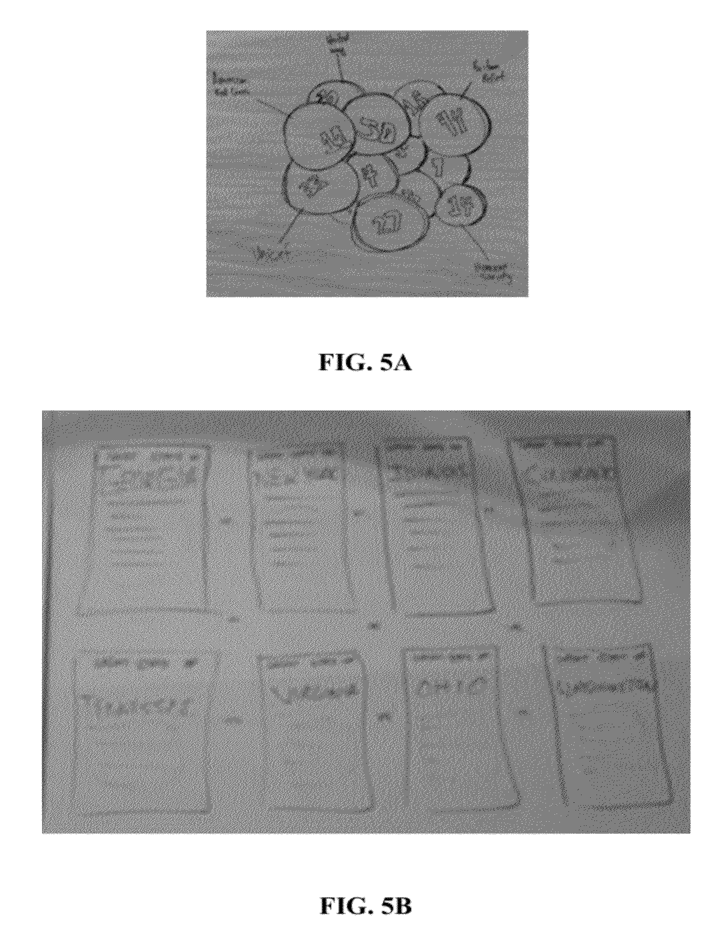

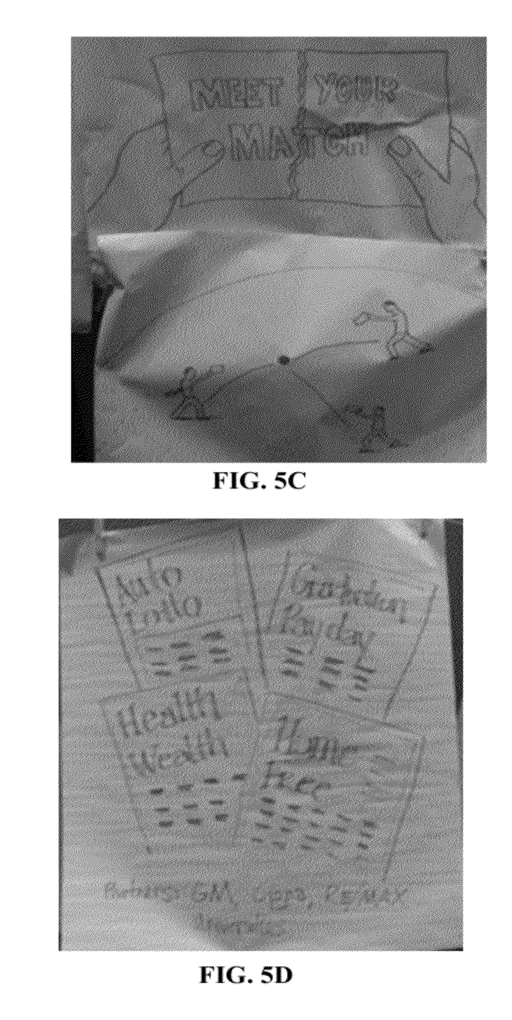

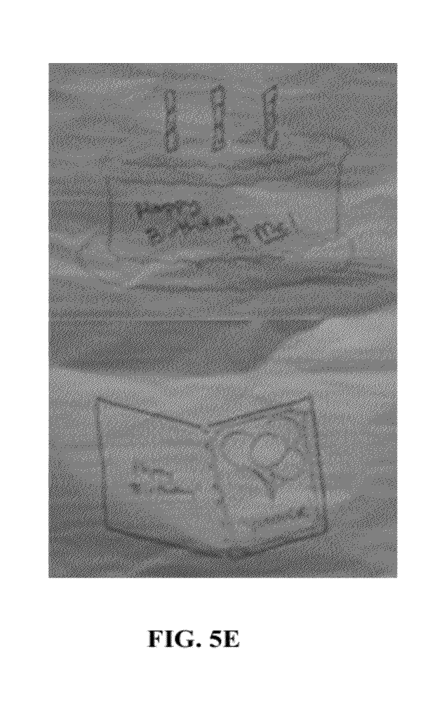

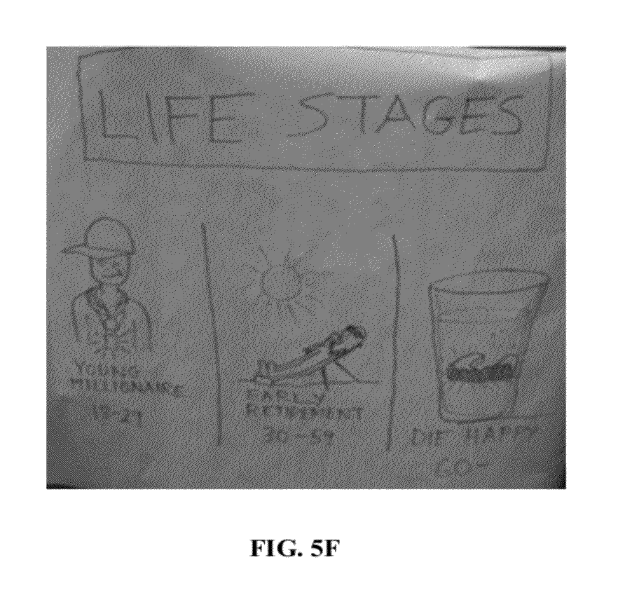

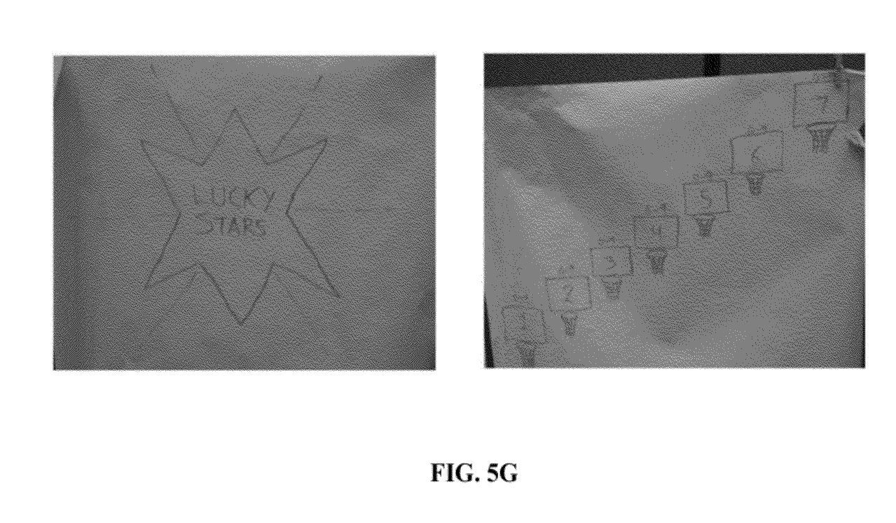

In one or more embodiments the lottery tickets described herein can have at least a portion of the second plurality of lottery game indicia conveying a monetary prize to the plurality of recipients comprising a lottery game player and the entity of choice. In certain embodiments, the first plurality and second plurality of lottery game indicia can be the indicia shown in FIG. 5A. A lottery game player can choose the last number based on the charity the number represents. When the lottery game player wins, a portion of the winnings goes to the lottery game player's chosen charity.

In a further embodiment, the lottery tickets described herein can have at least a portion of the first plurality of lottery game indicia comprising a group of selectable themes. In yet a further embodiment the lottery tickets described herein can have at least a portion of the second plurality of lottery game indicia conveying a monetary prize to the plurality of recipients comprising a set of recipients associated with the highest ranked theme. In one embodiment, the first and second plurality of lottery game indicia can be the indicia shown in FIG. 5B.

Examples of themes that can be represented on the lottery tickets described herein include, but are not limited to states, sports teams, movies, books, musical artists, cities, universities, or animals. In still a further embodiment, the lottery ticket can be an online ticket that can be obtained on a webpage which can be designed around at least one of the themes appearing on the lottery ticket. In one embodiment, the lottery tickets described herein allow lottery game players to align themselves with other lottery game players that have common interests.

In a further embodiment, the lottery tickets described herein can have at least a portion of the first plurality of lottery game indicia comprising a group of symbols. For example, and not to be limiting, the symbols can be letters, numbers, characters, or emoticons. In yet a further embodiment, the lottery tickets described herein can have at least a portion of the second plurality of lottery game indicia conveying a monetary prize to the plurality of recipients comprising the lottery game players that co-locate and jointly surrender matching tickets. In one embodiment, the first and second plurality of lottery game indicia can be the indicia shown in FIG. 5C.

In a further embodiment, the lottery tickets described herein can have two lottery game players that co-locate and jointly surrender matching tickets. In still a further embodiment, there can be three winning tickets, such that three people can possess them. After the announcement of a predetermined winning number, a race can begin to find the other winning tickets. In yet a further embodiment, the lottery game player that does not co-locate and jointly surrender a matching ticket can receive a consolation prize of monetary value. In another embodiment there can be a limited amount of time to find the other matching ticket.

In a further embodiment, the lottery tickets described herein can have at least a portion of the first plurality of lottery game indicia comprising a group of symbols. For example, and not to be limiting, the symbols can be letters, numbers, characters, or emoticons. In yet a further embodiment, the lottery tickers described herein can have at least a portion of the second plurality of lottery game indicia conveying a monetary prize to the plurality of recipients comprising a selected lottery game player and one or more other non-selected lottery game players having a specific amount of tickets according to a criteria. For example, and not to be limiting, the specific amount of tickets can be the highest percentage of tickets obtained by an individual lottery game player or a group of lottery game players according to the total number of lottery tickets obtained by all lottery game players. In one embodiment, a the selected lottery game player and the non-selected lottery game players can divide a national prize fund.

In a further embodiment, the lottery tickets described herein can have at least a portion of the first plurality of lottery game indicia comprising a set of symbols. For example, and not to be limiting, the symbols can be letters, numbers, characters, or emoticons. In a further embodiment, the lottery tickets described herein can have one or more removable portions suitable for providing to at least one other individual. The at least one other individual can a friend, neighbor, relative, family member, or other entity. For example, and not to be limiting, the removable portion of the lottery ticket can be a piece of substrate that can by physically separated from the ticket, or it can be a message delivered to a recipient on a device. In yet a further embodiment, the lottery tickets described herein can have at least a portion of the second plurality of lottery game indicia conveying a monetary prize to the plurality of recipients comprising a lottery game player and the at least one other individual having at least one of the removable portions. For example, and not to be limiting, the lottery game player can win one million dollars and the other recipients can win fifty thousand dollars each.

In a further embodiment, the lottery tickets described herein can have at least a portion of the first plurality of lottery game indicia comprising one pseudo-randomly generated symbol belonging to a sequence of winning symbols. For example, and not to be limiting, the symbol can be a letter, number, character, or emoticon. In certain embodiments, the symbols can be one number of a color-coded sequence.

In a further embodiment, the lottery tickets described herein can have at least a portion of the second plurality of lottery game indicia conveying a monetary prize to the plurality of recipients comprising the first group of lottery game players each having one symbol in the sequence of winning symbols that co-locate and jointly surrender the full sequence of winning symbols. For example, and not to be limiting, the first group of lottery game players to meet and turn in a winning ticket can win the most valuable monetary prize. The second and third sets can win less valuable monetary prizes. In one embodiment, the location of lottery game players with tickets can be delivered to a device through, for example, and not to be limiting, a social networking website or a reality television program.

In yet another embodiment there can be some numbers that are plentiful among lottery game players and others numbers that are less plentiful.

In a further embodiment, the lottery tickets described herein can have at least a portion of the first plurality of lottery game indicia comprising a group of symbols, wherein each symbol represents a non-cash monetary prize that indicates a benefit to a lottery game player and an entity that provides the non-cash monetary prize. For example, and not to be limiting, the symbols can be letters, numbers, characters, or emoticons. In a further embodiment, the symbols can be the terms “Auto Lotto”, “Graduation Payday”, “Health Wealth”, or “Home Free”. In one or more embodiments, if a lottery game player wins “Auto Lotto” then the lottery game player can win a Ford, GM, or Chrysler product; if a lottery game player wins “Health Wealth's”, the prize can be free health care of life; or if a lottery game player wins “Home Free”, the prize can be a home which is owned by someone who no longer can pay the mortgage. In one embodiment, the first and second plurality of lottery game indicia can be the indicia shown in FIG. 5D

In a further embodiment, the lottery tickets described herein can have at least a portion of the second plurality of lottery game indicia conveying a monetary prize to the plurality of recipients comprising the lottery game player and the entity providing the non-cash monetary prize. In one embodiment, not only can a lottery game player win a home, but a struggling family can get bought out so they don't have to go through foreclosure.

Described herein are lottery tickets comprising: a substrate; a first plurality of lottery game indicia prepared in the substrate and that defines a lottery game; and a second plurality of lottery game indicia prepared in the substrate and conveying a monetary prize redeemable over a period of time. The monetary prize can be a cash prize or a non-cash prize. In some embodiments, the lottery tickets described herein can further comprise an electronic medium, including, but not limited to, a computer readable medium.

In one embodiment, at least a portion of the plurality of lottery game indicia can be covered by a scratch off coating, and at least a portion of the plurality of lottery game indicia can be exposed by removing the scratch off coating.

In one embodiment, the scratch off coating can be removed by a lottery game player. In another embodiment, the scratch off coating can be removed by an individual administering the lottery game. Administering the lottery game can include, but is not limited to, selling the lottery tickets, providing prizes to winning lottery game players, or determining if a lottery game player has a winning ticket. In a further aspect, the scratch off coating can be removed by a device.

In one embodiment, the first plurality of lottery game indicia can be delivered to a device in response to the purchase of the lottery ticket. For example, and not to be limiting, the device can be a cellular phone, a PDA, a desktop computer, a laptop computer, or a television. In another embodiment, the first plurality of lottery game indicia can be delivered to the device by text message, email, instant message, through a social networking site, a phone call, or downloaded directly to the device from a server.

In a further embodiment, the lottery tickets described herein can have at least a portion of the first plurality of lottery game indicia comprising a group of symbols. For example, and not to be limiting, the symbols can be letters, numbers, characters, or emoticons.

In yet a further embodiment the lottery tickets described herein can have at least a portion of the second plurality of lottery game indicia conveying a monetary prize that is a specific first cash sum and enables competition for a second cash sum, and wherein the monetary prize is redeemable at a first instant in response to the determination of a winning ticket, and at a second instant after the end of the competition for the second cash sum. For example, and not to be limiting, the competition can take place on a television show. In one embodiment, the viewers of the television show can vote during elimination rounds. In another embodiment, celebrities can put the contestants through a variety of challenges, including, but not limited to reviewing their financial plans for spending the cash sum or reviewing their plans to donate some or all of the cash sum. In yet a further embodiment, the public can vote on the best plan each week.

In a further embodiment, the lottery tickets described herein can have at least a portion of the first plurality of lottery game indicia comprising a pseudo-randomly generated sequence of symbols. For example, and not to be limiting, the symbols can be letters, numbers, characters, or emoticons.

In yet a further embodiment, the lottery tickets described herein can have at least a portion of the second plurality of lottery game indicia conveying a monetary prize comprising a non-cash monetary prize. In one embodiment, the non-cash prize, can be a “kingdom” for a predetermined time period. In a further embodiment, the kingdom can be a tropical island. In yet a further embodiment, the winning lottery game player can choose to bring other individuals with them to the island. In still a further embodiment the group's activity on the island can be recorded and that activity can be broadcast by a television program.

In still a further embodiment, the non-cash monetary prize can be redeemed over a pre-determined time. For example, but not to be limiting, the pre-determined time can be less than a year, a year, or more than a year.

In a further embodiment, the lottery tickets described herein can have at least a portion of the first plurality of lottery game indicia comprising a group of symbols. For example, and not to be limiting, the symbols can be letters, numbers, characters, or emoticons.

In yet a further embodiment, the lottery tickets described herein can have at least a portion of the second plurality of lottery game indicia conveying a monetary prize comprising a monetary instrument with a predetermined spending limit. A monetary instrument can be, but is not limited to, a credit card, a debit card, a gift card, or an online gift card. In one embodiment, the monetary instrument can be a card that can be metal and can have the lottery game player's name on it. In a further embodiment, the monetary instrument can be a credit card with no limit. In yet a further embodiment, the monetary prize can be redeemed over a course of a predetermined amount of time. For example, and not to be limiting, the predetermined amount of time can be one month, six months, one year or greater than one year.

In a further embodiment, the lottery tickets described herein can have at least a portion of the first plurality of lottery game indicia comprising a group of symbols. For example, and not to be limiting, the symbols can be letters, numbers, characters, or emoticons.

In yet a further embodiment, the lottery tickets described herein can have at least a portion of the second plurality of lottery game indicia conveying a monetary prize comprising a monetary instrument with an undisclosed spending limit. A monetary instrument can be, but is not limited to, a credit card, a debit card, a gift card, or an online gift card. In one embodiment, the monetary instrument can be Visa, American Express, or MasterCard. In a further embodiment more than one lottery game player can win a monetary instrument. In yet a further embodiment, each lottery game player's monetary instrument can be preloaded with an undisclosed amount, wherein at least one monetary instrument can have a different spending limit. In still a further embodiment, the monetary prize can be redeemed over a time interval. The time interval can include, but is not limited to, less than 1 day, 1 day, 2 days, 5 days, a week 2 weeks, a month, 6 months, a year, more than a year or any time interval in between.

Described herein are lottery tickets, comprising: a substrate; a first plurality of lottery game indicia prepared in the substrate and that defines a lottery game; and a second plurality of lottery game indicia prepared in the substrate and that conveys a monetary prize provided to a lottery game player and a monetary prize provided to an entity selected by the lottery game player. The monetary prize can be a cash prize or a non-cash prize. In some embodiments, the lottery tickets described herein can further comprise an electronic medium, including, but not limited to, a computer readable medium.

In one embodiment, at least a portion of the plurality of lottery game indicia can be covered by a scratch off coating, and at least a portion of the plurality of lottery game indicia can be exposed by removing the scratch off coating.

In one embodiment, the scratch off coating can be removed by a lottery game player. In another embodiment, the scratch off coating can be removed by an individual administering the lottery game. Administering the lottery game can include, but is not limited to, selling the lottery tickets, providing prizes to winning lottery game players, or determining if a lottery game player has a winning ticket. In a further aspect, the scratch off coating can be removed by a device.

In one embodiment, the first plurality of lottery game indicia can be delivered to a device in response to the purchase of the lottery ticket. For example, and not to be limiting, the device can be a cellular phone, a PDA, a desktop computer, a laptop computer, or a television. In another embodiment, the first plurality of lottery game indicia can be delivered to the device by text message, email, instant message, through a social networking site, a phone call, or downloaded directly to the device from a server.

In a further embodiment, the lottery tickets described herein can have at least a portion of the first plurality of lottery game indicia comprising a group of symbols. For example, and not to be limiting, the symbols can be letters, numbers, characters, or emoticons.

In yet a further embodiment, the lottery tickets described herein can have at least a portion of the second plurality of lottery game indicia conveying a monetary prize comprising a first cash sum provided to a lottery game player and a second cash sum provided to a fund. In still a further embodiment, the lottery tickets described herein can have at least a portion of the second plurality of lottery game indicia conveying a monetary prize that allows the joining of other lottery game players for managing the fund. In one aspect, the fund can provided to an entity selected by the group of other lottery game players. For example, and not to be limiting, the group can be less than 5 lottery game players, 5 lottery game players, 10 lottery game players, 20 lottery game players, or more than 20 lottery game players.

In a further embodiment, non-lottery game players can contribute ideas to the lottery game players on how to provide the fund. Ideas can include, but are not limited to providing the fund to at least one charity, providing the fund to at least one government program, providing the fund to the National Aeronautics and Space Administration, or providing the fund to at least one disaster relief organization. In yet a further embodiment, the group of lottery game players can select their favorite idea in accordance with input from a user device associated with the lottery game players and the fund can be provided according to the selection.

In a further embodiment, the lottery tickets described herein can have at least a portion of the first plurality of lottery game indicia comprising a symbol conveying a monetary prize. For example, and not to be limiting, the symbols can be letters, numbers, characters, or emoticons.

In yet a further embodiment, the lottery tickets described herein can have one or more removable portions suitable for providing to at least one other individual. For example, and not to be limiting the other recipients can be friends, neighbors, relatives, family members, or other entities. The removable portion of the lottery ticket can be a piece of substrate that can by physically separated from the ticket, or it can be a message delivered to a recipient on a device. In one embodiment, the first and second plurality of lottery game indicia can be the indicia shown in FIG. 5C.

In still a further embodiment, the lottery tickets described herein can have at least a portion of the second plurality of lottery game indicia conveying a monetary prize to the lottery game player and the at least one other individual having at least one of the removable portions. For example, and not to be limiting, the lottery game player can win one million dollars and the other recipients can win one million dollars each that can be used to pay off the recipient's debt.

In a further embodiment, the lottery tickets described herein can have at least a portion of the first plurality of lottery game indicia comprising a group of symbols. For example, and not to be limiting, the symbols can be letters, numbers, characters, or emoticons.

In yet a further embodiment, the lottery tickets described herein can have at least a portion of the second plurality of lottery game indicia conveying a monetary prize that is provided to a lottery game player, wherein the monetary prize enables expenditure of tax payments in accordance with input from a user device associated with the lottery game player. In still a further embodiment, the lottery game player can choose to spend the tax payments on any government issue or eligible program. For example, and not to be limiting, the lottery game player can choose to spend the tax payment on lowering the national debt, education, health care, social security, or infrastructure improvements.

Described herein are lottery tickets comprising: a substrate; a first plurality of lottery game indicia prepared in the substrate and that defines a lottery game; and a second plurality of lottery game indicia prepared in the substrate and that conveys a monetary prize provided to a segment of a plurality of lottery game players. The monetary prize can be a cash prize or a non-cash prize. In some embodiments, the lottery tickets described herein can further comprise an electronic medium, including, but not limited to, a computer readable medium.

In one embodiment, at least a portion of the plurality of lottery game indicia can be covered by a scratch off coating, and at least a portion of the plurality of lottery game indicia can be exposed by removing the scratch off coating.

In one embodiment, the scratch off coating can be removed by a lottery game player. In another embodiment, the scratch off coating can be removed by an individual administering the lottery game. Administering the lottery game can include, but is not limited to, selling the lottery tickets, providing prizes to winning lottery game players, or determining if a lottery game player has a winning ticket. In a further aspect, the scratch off coating can be removed by a device.

In one embodiment, the first plurality of lottery game indicia can be delivered to a device in response to the purchase of the lottery ticket. For example, and not to be limiting, the device can be a cellular phone, a PDA, a desktop computer, a laptop computer, or a television. In another embodiment, the first plurality of lottery game indicia can be delivered to the device by text message, email, instant message, through a social networking site, a phone call, or downloaded directly to the device from a server.

In a further embodiment, the lottery tickets described herein can have at least a portion of the first plurality of lottery game indicia comprising a group of symbols. For example, and not to be limiting, the symbols can be letters, numbers, characters, or emoticons. In yet a further aspect, the lottery tickets can be a birthday card.

In still a further embodiment, the lottery tickets described herein can have at least a portion of the second plurality of lottery game indicia conveying a monetary prize that can be provided to a lottery game player having a birthday on the day of determining a winning realization for the lottery game. In one embodiment, the first and second plurality of lottery game indicia can be the indicia shown in FIG. 5E.

In one embodiment there can be a group of winning lottery game players having a birthday on the day of determining a winning realization for the lottery game. A first individual lottery game player can win a first monetary prize, and a second group of lottery game players can win a second monetary prize, wherein the second monetary prize has less monetary value compared to the first monetary prize.

In one embodiment, a lottery game player can obtain a lottery ticket up until 72 hours before the midnight of their birthday. In a further embodiment, non-lottery game player can obtain the lottery ticket and can and provide the ticket to the lottery game player.

In a further embodiment, the lottery tickets described herein can have at least a portion of the first plurality of lottery game indicia indicating a specific age group. In still a further aspect, the lottery tickets described herein can have at least a portion of the second plurality of lottery game indicia conveying a monetary prize to a lottery game player in the specific age group. For example, and not to be limiting, the age group can be the 18-29 age group, the 30-64 age group, or the 65+ age group. In one embodiment, the first and second plurality of lottery game indicia can be the indicia shown in FIG. 5F. In a further embodiment, the monetary prize can be specifically designed for each particular age group.

Described herein are lottery tickets comprising: a substrate; and a first plurality of lottery game indicia prepared in the substrate, wherein the first plurality of lottery game indicia comprises a first group of symbols; wherein the first group of symbols render the lottery ticket a winning ticket when each symbol of the first group of symbols matches each symbol of a second group of symbols determined by a celebrity through performance of predetermined activity. The monetary prize can be a cash prize or a non-cash prize. A celebrity can include, but is not limited to an actor, an actress, a sports figure, a politician, a model, a reality television star, or a musician. In one embodiment, the lottery ticket can be obtained online. In one embodiment, winning numbers can be selected by a celebrity who can determine the winning numbers in a variety of ways. For example, and not to be limiting, when the celebrity is a basketball player, a challenge can be arranged that utilizes the basketball player's point total in a game to determine the winning numbers. In one embodiment, the first and second plurality of lottery game indicia can be the indicia shown in FIG. 5G.

In a further embodiment, the celebrity and the celebrity's determination of winning numbers can be announced no more than 24 hours before the determination. In a further embodiment, lottery game players can choose to play according to the celebrity. In yet a further embodiment, the price of the lottery ticket can escalate as the time for the celebrity drawing gets closer.

In one embodiment, the first plurality of lottery game indicia can be delivered to a device in response to the purchase of the lottery ticket. For example, and not to be limiting, the device can be a cellular phone, a PDA, a desktop computer, a laptop computer, or a television. In another embodiment, the first plurality of lottery game indicia can be delivered to the device by text message, email, instant message, through a social networking site, a phone call, or downloaded directly to the device from a server.

Described herein are lottery tickets comprising: a substrate; a first plurality of lottery game indicia prepared in the substrate and that represents a set of N numbers; and a second plurality of lottery game indicia prepared in the substrate and that conveys a monetary prize, wherein the monetary prize is determined a number N of times in a time interval at the Nth hour of a day in the time interval, wherein N is natural number.

In one embodiment the lottery ticket can have at least a portion of the second plurality of indicia conveying N monetary prize levels. In a further embodiment, the monetary prize can be multiplied by a predetermined factor on the Nth day of the Nth month. For example, and not to be limiting N can be 1, 2, 3, 4, 5, 6, 7, 8, 9, 10, 11, or 12.

Described herein are lottery tickets comprising: a substrate; a first plurality of lottery game indicia prepared in the substrate and that represents a holiday; and a second plurality of lottery game indicia prepared in the substrate and that conveys a monetary prize, wherein the monetary prize can be provided to a winning lottery game player only on the holiday indicated on the ticket. For example, and not to be limiting, the holiday can be New Years, Valentine's Day, St. Patrick's Day, Tax Day (April 15th), Memorial Day, the Fourth of July, Labor Day, Halloween, or Thanksgiving.

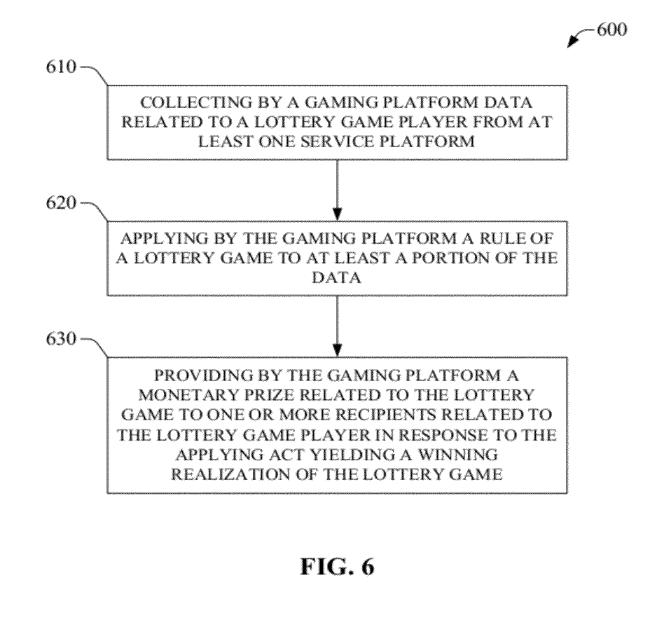

In view of the aspects described hereinbefore, an exemplary method that can be implemented in accordance with the disclosed subject matter can be better appreciated with reference to the flowchart in FIG. 6. For purposes of simplicity of explanation, the exemplary method disclosed herein is presented and described as a series of acts; however, it is to be understood and appreciated that the claimed subject matter is not limited by the order of acts, as some acts may occur in different orders and/or concurrently with other acts from that shown and described herein. For example, the various methods or processes of the subject disclosure can alternatively be represented as a series of interrelated states or events, such as in a state diagram. Moreover, when disparate functional elements implement disparate portions of the methods or processes in the subject disclosure, an interaction diagram or a call flow can represent such methods or processes. Furthermore, not all illustrated acts may be required to implement a method in accordance with the subject disclosure. Further yet, two or more of the disclosed methods or processes can be implemented in combination with each other, to accomplish one or more features or advantages herein described. It should be further appreciated that the exemplary methods disclosed throughout the subject specification can be stored on an article of manufacture, or computer-readable medium, to facilitate transporting and transferring such methods to computers for execution, and thus implementation, by a processor or for storage in a memory.

FIG. 6 is a flowchart of an exemplary gaming method in accordance with aspects of the subject innovation. At act 610, data related to a lottery game player is collected by a gaming platform (e.g., 110) from at least one service platform (e.g., server(s) 130). The subject act is referred to as the collecting act. At act 620, a rule of a lottery game is applied by the gaming platform (e.g., 110). In certain embodiments, the rule is applied to a portion of the data. The subject act is referred to as the applying act. At act 630, a monetary prize (e.g., prize 140) related to the lottery game is provided to one or more recipients related to the lottery game player in response to application of the rule in act 620 yielding a winning realization of the lottery game.

In an aspect, the applying act comprises providing a plurality of levels, each level of the plurality of levels representing a set of one or more permitted winners and associated with a specified monetary prize; and conveying indicia (e.g., a symbol, such as a number, or other pictorial representation of information) indicative of a number of existing winners in a level.

In another aspect, as described hereinbefore, the lottery game can exploit home addresses and thus the collecting act can comprise receiving a home address or a portion thereof (e.g., street number, street name, city, state, country, or any combination thereof). For such data, the applying act can comprise selecting a first home address and comparing the first home address with a second home address extracted from a plurality of received home addresses. In certain scenarios, the plurality of received home addresses can be received as part of the collecting act. In addition, the applying act can further comprise assigning a first prize to a recipient linked to the first address in response to a match between the first address and the second address. It should be appreciated, the match between the first address and the second address can be the performance criterion defined by the rule of the lottery game.

In yet another aspect, the collecting act can comprise receiving data indicative of authorization to bill a commercial account linked to the lottery game player in response to purchase of a lottery ticket for the lottery game. As described hereinbefore, such authorization can be germane to the mechanics of the lottery game, the authorization enabling the lottery game player to participate in the lottery game. The commercial account enables a commercial transaction amongst the lottery game player a service provider (a utility company; a service provider such as; a financial organization such as a bank, a credit union, a lender; etc.), wherein the commercial transaction includes billing costs associated with purchase of lottery ticket(s). The commercial account can be embodied in a bank account, a credit card account, a utility billing account, a loyalty program account, or the like. Accordingly, in certain embodiments, example method 600 further comprises billing the commercial account linked to the lottery game player for at least a portion of a fee of the lottery ticket for the lottery game in response to purchase of the lottery ticket for the lottery game.

In one embodiment, the applying act can comprise extracting a token, and assigning a cumulative winnings to the lottery game player in response to a predetermined token in a predetermined sequence of tokens matching the predetermined token. Extraction of the token can be contemplated, or defined, in the rule of the lottery game and thus application of such rule comprises extraction of the token. In a scenario, as described supra, the cumulative winnings results from addition of a previous cumulative winnings and a predetermined increment. Such matching can be a performance criterion that establishes a winning realization and thus affords assignment of the cumulative winnings.

In such one embodiment, example method 600 can further comprise reiterating the extracting step unless a monetary prize based on the cumulative winnings is redeemed or the predetermined sequence of tokens is exhausted. In an aspect, the monetary prize based on the cumulative winnings is determined by a number of instances the predetermined token has matched an extracted token produced by the extracting act.

In additional or alternative embodiment, exemplary method 600 can further comprise providing by the service platform a plurality of clues indicative of a specific location. A clue can be a volume of information (e.g., a portion of written language, a symbol, an aural token, a tactile token, etc.) that conveys one or more features related to the specific location. In an aspect of such additional or alternative embodiments, the providing act comprises conveying at least one clue of the plurality of clues to a user-device. The user-device can embody interface 150. In another aspect, the providing act comprises providing at least one clue of the plurality of clues to a manufacturing platform that produces a lottery ticket comprising a substrate having a representation of the at least one clue. The manufacturing platform can be a subsidiary of an entity that owns, leases, or otherwise controls the gaming platform (e.g., 110). In yet another aspect, the providing act comprises embedding at least one clue of the plurality of clues in a television broadcast. For instance, the embedding can include generating custom advertisement of the lottery game, wherein the advertisement is conveyed as part of the television broadcast. In still another aspect, the providing act can comprise embedding at least one clue of the plurality of clues in a publication wherein the publication can be delivered or carried in various media such as an electronic book, a non-electronic book, a web-based publication, an aural publication such as a radio broadcast, a public announcement, an automated voice call, or the like.

In such additional or alternative embodiment, the applying act can comprise determining the specific location has been found. Various mechanisms can enable determination that a certain location has been found based on one or more clues; for instance, a user-device (a mobile telephone, a wireless computer, a portable computer that is either tethered or wireless, etc.) can be supply an image of identifying indicia coupled to a fixture in the specific location; the gaming platform or a unit therein (e.g., a prize generator) can perform an assessment of the image and based on an outcome of the assessment determined the specific location has been found. In the alternative, the user-device can supply an electronic communication (Short Message Service (SMS) communication, Multimedia Message Service (MMS) communication, email message, or any or most any data packet) in response to the identifying indicia matching other indicia present in a lottery ticket or, more generally, a gaming instrument (e.g., a rendering of a lottery ticket in a user-device display) or provided by one or more clues.

In embodiments of example method 600 that include collecting a plurality of clues, the providing act can comprise awarding the prize in response to the specific location being found. In an aspect, as described supra, the awarding act can include awarding a winnings determined by a number of previous instances the specific location has been found.

In a scenario in which the lottery game exploits a pool of telephone numbers as a domain of tokens that enable gameplay of the lottery game, the collecting act can comprise receiving data indicative of a telephone number of a user device of the lottery game player. It should be appreciated that collecting or receiving such type of data also can be performed in other scenarios.

In such scenario, in an aspect of exemplary method 600, the applying act can comprise initiating a call session (e.g., a voice call or a data session) with the user device via the telephone number. The call session can be at least one of a SMS communication, MMS communication, an Unstructured Supplementary Service Data (USSD) code, or a voice call. In another aspect, in response to failure to establish the call session (e.g., the voice call or the data session) with the user device, the applying act can further comprise initiating other call session with other user device associated with the lottery game player.

In addition, in response to establishing the other call session with other user device, the providing act can comprise awarding a first portion of the monetary prize to the lottery game player and a second portion of the monetary prize to an individual linked to the other user device. As described supra, the first portion can equal the second portion; however other relative weights, or proportions, for the first portion and the second portion can be exploited. In an alternative aspect, the providing act can comprise awarding the monetary prize in response to establishing the call session with the user device.

In certain scenarios, in an aspect of the exemplary method 600, the applying act can comprise delivering data indicative of a period available for spending a cash sum. As an example, the period can be 24 hours and the cash sum can be $24,000,000. Yet, it should be appreciated that any or most any period and any or most any cash sum can be exploited for game of the lottery game. In addition, in such scenarios, the applying act can comprise supplying data indicative of one or more rules for spending the cash sum. It should be appreciated that such one or more rules can embody, at least in part, the rule of the lottery game. Moreover, the collecting act can comprise receiving data representative of a spending plan in response to the delivering act. In such scenarios, the monetary prize equals the cash sum multiplied by a factor greater than unity.

In other embodiments of exemplary method 600, the collecting act can comprise receiving from a server (e.g., one of group of one or more server(s) 130) data indicative of at least one individual associated with the lottery game player, wherein the server is configure to provide or provides service to a social networking service provider. Moreover, the providing act can comprise awarding the monetary prize to the lottery game player and the at least one individual associated with the lottery game player.

In an embodiment, the collecting act comprises receiving data indicative of a residential location of the lottery game player, wherein the data indicative of the residential location comprises a geocode including at least one of a state code, an area code, or a ZIP code. In such embodiment, the providing act can comprise awarding the monetary prize to one or more lottery game players having a common residential location. It should be appreciated that in alternative embodiments, the collecting act can comprise receiving data indicative of a commercial location of the lottery game player, wherein the lottery game player can be an institutional game player or a bidder; for instance, the institutional game player can be a small business organization and the lottery game player can be a corporate tax deduction.

In such embodiment, exemplary method 600 can further comprise issuing by the gaming platform (e.g., gaming platform 110) a group of indicia (e.g., a plurality of symbols or tokens that are visual, aural, or tactile) representative of the location of the lottery game player, wherein the group of indicia is at least one of printed onto a lottery ticket, coated onto the lottery ticket, engraved onto the lottery ticket, or encoded (programmed in a memory, recorded in a memory, etc.) onto the lottery ticket, wherein the lottery ticket enables game play of the lottery game.

Several advantages of the subject disclosure emerge from the embodiments and related aspects described hereinbefore. Such advantages can include increased lottery game player enjoyment and participation, with ensuing increase in lottery sales and attendant money prizes. In addition, such advantages can include broad national interest and demographic engagement. Such advantages also can include rich prize structure that enables complex profit planning and systematic exploitation of profit opportunities for a lottery operator, and extension of prize awards in time and scope.

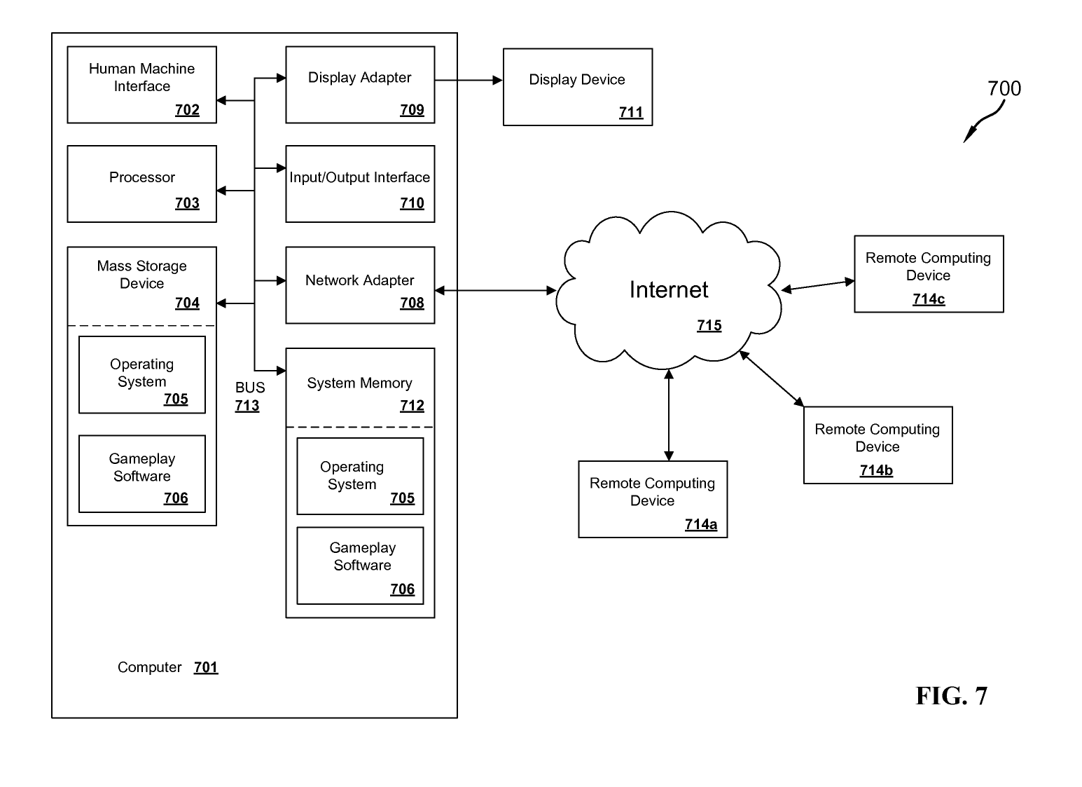

FIG. 7 illustrates a block diagram of an exemplary operating environment 700 that enables various features of the subject disclosure and performance of the various methods disclosed herein. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The various embodiments of the subject disclosure can be operational with numerous other general purpose or special purpose computing system environments or configurations. Examples of well known computing systems, environments, and/or configurations that can be suitable for use with the systems and methods comprise, but are not limited to, personal computers, server computers, laptop devices or handheld devices, and multiprocessor systems. Additional examples comprise wearable devices, mobile devices, set top boxes, programmable consumer electronics, network PCs, minicomputers, mainframe computers, distributed computing environments that comprise any of the above systems or devices, and the like.

The processing effected in the disclosed systems and methods can be performed by software components. The disclosed systems and methods can be described in the general context of computer-executable instructions, such as program modules, being executed by one or more computers or other computing devices. Generally, program modules comprise computer code, routines, programs, objects, components, data structures, etc. that perform particular tasks or implement particular abstract data types. The disclosed methods also can be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 701. The components of the computer 701 can comprise, but are not limited to, one or more processors 703, or processing units 703, a system memory 712, and a system bus 713 that couples various system components including the processor 703 to the system memory 712. In the case of multiple processing units 703, the system can utilize parallel computing.

In general, a processor 703 or a processing unit 703 refers to any computing processing unit or processing device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally or alternatively, a processor 703 or processing unit 703 can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors or processing units referred to herein can exploit nano-scale architectures such as, molecular and quantum-dot based transistors, switches and gates, in order to optimize space usage or enhance performance of the computing devices that can implement the various aspects of the subject disclosure. Processor 703 or processing unit 703 also can be implemented as a combination of computing processing units.

The system bus 713 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 713, and all buses specified in this description also can be implemented over a wired or wireless network connection and each of the subsystems, including the processor 703, a mass storage device 704, an operating system 705, gameplay software 706, gameplay data 707, a network adapter 708, system memory 712, an Input/Output Interface 710, a display adapter 709, a display device 711, and a human machine interface 702, can be contained within one or more remote computing devices 714a,b,c at physically separate locations, connected through buses of this form, in effect implementing a fully distributed system. In an aspect, gameplay software code 706 can comprise gaming platform 110 and various components therein (see, e.g., FIG. 1, or FIG. 2); such components can be embodied in code instructions and executed by processing unit 703.

The computer 701 typically comprises a variety of computer readable media. Exemplary readable media can be any available media that is accessible by the computer 701 and comprises, for example and not meant to be limiting, both volatile and non-volatile media, removable and non-removable media. The system memory 712 comprises computer readable media in the form of volatile memory, such as random access memory (RAM), and/or non-volatile memory, such as read only memory (ROM). The system memory 712 typically contains data (such as rules for issuing a prize or rules for playing a lottery game) and/or program modules such as operating system 705 and gameplay software 706 that are immediately accessible to and/or are presently operated on by the processing unit 703. Operating system 705 can comprise OSs such as Windows operating system, Unix, Linux, Symbian, Android, iOS, Chromium, and substantially any operating system for wireless computing devices or tethered computing devices.

In another aspect, the computer 701 also can comprise other removable/non-removable, volatile/non-volatile computer storage media. By way of example, FIG. 7 illustrates a mass storage device 704 which can provide non-volatile storage of computer code, computer readable instructions, data structures, program modules, and other data for the computer 701. For example and not meant to be limiting, a mass storage device 704 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 704, including by way of example, an operating system 705, and gameplay software 706. Each of the operating system 705 and gameplay software 706 (or some combination thereof) can comprise elements of the programming and the gameplay software 706. Data and code (e.g., computer-executable instruction(s)) can be retained as part of gameplay software 706 and can be stored on the mass storage device 704. Gameplay software 706, and related data and code, can be stored in any of one or more databases known in the art. Examples of such databases comprise, DB2®, Microsoft®Access, Microsoft® SQL Server, Oracle®, mySQL, PostgreSQL, and the like. Further examples include membase databases and flat file databases. The databases can be centralized or distributed across multiple systems.

In another aspect, the user can enter commands and information into the computer 701 via an input device (not shown). Examples of such input devices comprise, but are not limited to, a camera; a keyboard; a pointing device (e.g., a “mouse”); a microphone; a joystick; a scanner (e.g., barcode scanner); a reader device such as a radiofrequency identification (RFID) readers or magnetic stripe readers; gesture-based input devices such as tactile input devices (e.g., touch screens, gloves and other body coverings or wearable devices), speech recognition devices, or natural interfaces; and the like. These and other input devices can be connected to the processing unit 703 via a human machine interface 702 that is coupled to the system bus 713, but can be connected by other interface and bus structures, such as a parallel port, game port, an IEEE 1394 Port (also known as a Firewire port), a serial port, or a universal serial bus (USB).

In yet another aspect, a display device 711 also can be connected to the system bus 713 via an interface, such as a display adapter 709. It is contemplated that the computer 701 can have more than one display adapter 709 and the computer 701 can have more than one display device 711. For example, a display device can be a monitor, an LCD (Liquid Crystal Display), or a projector. In addition to the display device 711, other output peripheral devices can comprise components such as speakers (not shown) and a printer (not shown) which can be connected to the computer 701 via Input/Output Interface 710. Any step and/or result of the methods can be output in any form to an output device. Such output can be any form of visual representation, including, but not limited to, textual, graphical, animation, audio, tactile, and the like.

The computer 701 can operate in a networked environment using logical connections to one or more remote computing devices 714a,b,c. By way of example, a remote computing device can be a personal computer, portable computer, a mobile telephone, a server, a router, a network computer, a peer device or other common network node, and so on. Logical connections between the computer 701 and a remote computing device 714a,b,c can be made via a local area network (LAN) and a general wide area network (WAN). Such network connections can be through a network adapter 708. A network adapter 708 can be implemented in both wired and wireless environments. Such networking environments are conventional and commonplace in offices, enterprise-wide computer networks, intranets, and the Internet 715. Networking environments generally can be embodied in wireline networks or wireless networks (e.g., cellular networks, such as Third Generation (3G) and Fourth Generation (4G) cellular networks, facility-based networks (femtocell, picocell, Wi-Fi networks, etc.).

As an illustration, application programs and other executable program components such as the operating system 705 are illustrated herein as discrete blocks, although it is recognized that such programs and components reside at various times in different storage components of the computing device 701, and are executed by the data processor(s) of the computer. An implementation of gameplay software 706 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer-readable media can comprise “computer storage media,” or “computer-readable storage media,” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

While the systems, devices, apparatuses, protocols, processes, and methods have been described in connection with exemplary embodiments and specific illustrations, it is not intended that the scope be limited to the particular embodiments set forth, as the embodiments herein are intended in all respects to be illustrative rather than restrictive.

Unless otherwise expressly stated, it is in no way intended that any protocol, procedure, process, or method set forth herein be construed as requiring that its acts or steps be performed in a specific order. Accordingly, in the subject specification, where description of a process or method does not actually recite an order to be followed by its acts or steps or it is not otherwise specifically recited in the claims or descriptions of the subject disclosure that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification or annexed drawings, or the like.

It will be apparent to those skilled in the art that various modifications and variations can be made in the subject disclosure without departing from the scope or spirit of the subject disclosure. Other embodiments of the subject disclosure will be apparent to those skilled in the art from consideration of the specification and practice of the subject disclosure as disclosed herein. It is intended that the specification and examples be considered as non-limiting illustrations only, with a true scope and spirit of the subject disclosure being indicated by the following claims.

What is claimed is:

1. A lottery ticket, comprising:
a substrate;
a first plurality of lottery game indicia prepared in the substrate and that defines a lottery game; and
a second plurality of lottery game indicia prepared in the substrate and that conveys a monetary prize to a plurality of recipients.

2. The lottery ticket of claim 1, wherein at least a portion of the plurality of lottery game indicia is covered by a scratch off coating, and wherein at least a portion of the plurality of lottery game indicia is exposed by removing the scratch off coating.

3. The lottery ticket of claim 1, wherein the first plurality of lottery game indicia is delivered to a device in response to the purchase of the lottery ticket.

4. The lottery ticket of claim 1, wherein at least a portion of the first plurality of lottery game indicia comprises a set of symbols.

5. The lottery ticket of claim 4, wherein the ticket further comprises one or more removable portions suitable for providing to at least one other individual.

6. The lottery ticket of claim 5, wherein at least a portion of the second plurality of lottery game indicia conveys a monetary prize to the plurality of recipients comprising a lottery game player and the at least one other individual having at least one of the removable portions.

7. The lottery ticket of claim 1, wherein at least a portion of the first plurality of lottery game indicia comprises one pseudo-randomly generated symbol belonging to a sequence of winning symbols.

8. The lottery ticket of claim 7, wherein at least a portion of the second plurality of lottery game indicia conveys a monetary prize to the plurality of recipients comprising the first group of lottery game players each having one symbol in the sequence of winning symbols that co-locate and jointly surrender the full sequence of winning symbols.

9. The lottery ticket of claim 2, wherein at least a portion of the first plurality of lottery game indicia comprises a group of symbols, wherein each symbol represents a non-cash monetary prize that indicates a benefit to a lottery game player and an entity that provides the non-cash monetary prize.

10. The lottery ticket of claim 9, wherein at least a portion of the second plurality of lottery game indicia conveys a monetary prize to the plurality of recipients comprising the lottery game player and the entity providing the non-cash monetary prize.

11. A lottery ticket, comprising:
a substrate;
a first plurality of lottery game indicia prepared in the substrate and that defines a lottery game; and
a second plurality of lottery game indicia prepared in the substrate and that conveys a monetary prize redeemable over a period of time.

12. The lottery ticket of claim 11, wherein at least a first portion of at least one of the first plurality of lottery game indicia or the second plurality of lottery game indicia is covered by a scratch off coating, and wherein at least a second portion of at least one of the first plurality of lottery game indicia or the second plurality of lottery game indicia is exposed by removing the scratch off coating.

13. The lottery ticket of claim 11, wherein the first plurality of lottery game indicia is delivered to a device in response to the purchase of the lottery ticket.

14. The lottery ticket of claim 11, wherein at least a portion of the first plurality of lottery game indicia comprises a group of symbols.

15. The lottery ticket of claim 14, wherein at least a portion of the second plurality of lottery game indicia conveys a monetary prize that is a specific first cash sum and enables competition for a second cash sum, and wherein the monetary prize is redeemable at a first instant in response to the determination of a winning ticket, and at a second instant after the end of the competition for the second cash sum.

16. The lottery ticket of claim 11, wherein at least a portion of the first plurality of lottery game indicia comprises a pseudo-randomly generated sequence of symbols.

17. The lottery ticket of claim 16, wherein at least a portion of the second plurality of lottery game indicia conveys a monetary prize comprising a non-cash monetary prize, and wherein the non-cash monetary prize is redeemed over a pre-determined time.

18. The lottery ticket of claim 17, wherein the predetermined period of time is a year.

19. The lottery ticket of claim 11, wherein at least a portion of the first plurality of lottery game indicia comprises a group of symbols.

20. The lottery ticket of claim 19, wherein at least a portion of the second plurality of lottery game indicia conveys a monetary prize comprising a monetary instrument with a predetermined spending limit.

21. The lottery ticket of claim 20, wherein the monetary prize is redeemed over a course of a predetermined amount of time.

22. The lottery ticket of claim 13, wherein at least a portion of the first plurality of lottery game indicia comprises a group of symbols.

23. The lottery ticket of claim 22, wherein at least a portion of the second plurality of lottery game indicia conveys a monetary prize comprising a monetary instrument with an undisclosed spending limit.

24. The lottery ticket of claim 23, wherein the monetary prize is redeemed over a time interval.

25. A lottery ticket, comprising:
a substrate;
a first plurality of lottery game indicia prepared in the substrate and that defines a lottery game; and
a second plurality of lottery game indicia prepared in the substrate and that conveys a monetary prize provided to a lottery game player and a monetary prize provided to an entity selected by the lottery game player.

26. The lottery ticket of claim 25, wherein at least a first portion of at least one of the first plurality of lottery game indicia or the second plurality of lottery game indicia is covered by a scratch off coating, and wherein at least a second portion of at least one of the first plurality of lottery game indicia or the second plurality of lottery game indicia is exposed by removing the scratch off coating.

27. The lottery ticket of claim 25, wherein the first plurality of lottery game indicia is delivered to a user device in response to the purchase of the lottery ticket.

28. The lottery ticket of claim 25, wherein at least a portion of the first plurality of lottery game indicia comprises a group of symbols.

29. The lottery ticket of claim 28, wherein at least a portion of the second plurality of lottery game indicia conveys a monetary prize comprising a first cash sum provided to a lottery game player and a second cash sum provided to a fund.

30. The lottery ticket of claim 29, wherein at least a portion of the second plurality of lottery game indicia conveys a monetary prize that allows the joining of other lottery game players for managing the fund.

31. The lottery ticket of claim 30, wherein the fund is provided to an entity selected by the group of other lottery game players.

32. The lottery ticket of claim 26, wherein at least a portion of the first plurality of lottery game indicia comprises a symbol conveying a monetary prize.

33. The lottery ticket of claim 32, wherein the ticket further comprises one or more removable portions suitable for providing to at least one other individual.

34. The lottery ticket of claim 33, at least a portion of the second plurality of lottery game indicia conveys a monetary prize to the lottery game player and the at least one other individual having at least one of the removable portions.

35. The lottery ticket of claim 25 wherein at least a portion of the first plurality of lottery game indicia comprises a group of symbols.

36. The lottery ticket of claim 35, wherein at least a portion of the second plurality of lottery game indicia conveys a monetary prize that is provided to a lottery game player, and wherein the monetary prize enables expenditure of tax payments in accordance with input from a user device associated with the lottery game player.

37. A lottery ticket, comprising:
a substrate;
a first plurality of lottery game indicia prepared in the substrate and that defines a lottery game; and
a second plurality of lottery game indicia prepared in the substrate and that conveys a monetary prize provided to a segment of a plurality of lottery game players.

38. The lottery ticket of claim 37, wherein at least a first portion of at least one of the first plurality of lottery game indicia or the second plurality of game indicia is covered by a scratch off coating, and wherein at least a second portion of at least one of the first plurality of lottery game indicia or the second plurality of lottery game indicia is exposed by removing the scratch off coating.

39. The lottery ticket of claim 37, wherein the first plurality of lottery game indicia is delivered to a user device in response to the purchase of the lottery ticket.

40. The lottery ticket of claim 37, wherein at least a portion of the first plurality of lottery game indicia comprises a group of symbols.

41. The lottery ticket of claim 40, wherein the ticket is a birthday card.

42. The lottery ticket of claim 41, wherein at least a portion of the second plurality of lottery game indicia conveys a monetary prize that is provided to a lottery game player having a birthday on the day of determining a winning realization for the lottery game.

43. The lottery ticket of claim 37, wherein at least a portion of the first plurality of lottery game indicia indicates a specific age group.

44. The lottery ticket of claim 43, wherein at least a portion of the second plurality of lottery game indicia conveys a monetary prize to a lottery game player in the specific age group.

45. A lottery ticket, comprising:
a substrate; and
a first plurality of lottery game indicia prepared in the substrate, wherein the first plurality of lottery game indicia comprises a first group of symbols; wherein the first group of symbols render the lottery ticket a winning ticket when each symbol of the first group of symbols matches each symbol of a second group of symbols determined by a celebrity through performance of predetermined activity.

46. The lottery ticket of claim 45, wherein the first plurality of lottery game indicia is delivered to a user device in response to the purchase of the lottery ticket.

47. A lottery ticket comprising:
a substrate;
a first plurality of lottery game indicia prepared in the substrate and that represents a set of N numbers; and
a second plurality of lottery game indicia prepared in the substrate and that conveys a monetary prize, wherein the monetary prize is determined a number N of times in a time interval at the Nth hour of a day in the time interval, wherein N is natural number.

48. The lottery ticket of claim 47, wherein at least a portion of the second plurality of indicia conveys N monetary prize levels.

49. The lottery ticket of claim 48, wherein the monetary prize is multiplied by a predetermined factor on the Nth day of the Nth month.

50. The lottery ticket of claim 47, wherein N is at most 12.
